(19) United States
(12) Patent Application Publication
(10) Pub. No.: US 2019/0037263 A1
(43) Pub. Date: Jan. 31, 2019

(54) CONTENT MANAGEMENT DEVICE AND CONTENT REQUEST PROGRAM

(71) Applicant: Nomura Research Institute, Ltd., Tokyo (JP)

(72) Inventors: Harumoto NAKANO, Tokyo (JP); Masayuki Naito, Tokyo (JP)

(73) Assignee: Nomura Research Institute, Ltd., Tokyo (JP)

(21) Appl. No.: 16/144,803

(22) Filed: Sep. 27, 2018

Related U.S. Application Data
(63) Continuation of application No. PCT/JP2017/001669, filed on Jan. 19, 2017.

(30) Foreign Application Priority Data
Mar. 28, 2016 (JP) 2016-064504

(51) Int. Cl. H04N 21/2668; G06F 17/30; G06K 7/10; H04N 21/4223; H04N 21/437; H04N 21/239; H04N 21/475; H04N 21/472; H04N 21/81

(52) U.S. Cl. CPC H04N 21/2668; G06F 17/30876; G06K 7/10722; H04N 21/4223; H04N 21/816; H04N 21/2393; H04N 21/4755; H04N 21/472; H04N 21/437

(57) ABSTRACT

A content management device and a content request program. The content request program causes a terminal to function as a capture unit configured to capture a marker image, an identification unit configured to acquire identification information for specifying content, an output unit configured to transmit distribution request information including marker information extracted from the marker image and the identification information to a management server that manages a plurality of pieces of content, and a reception unit configured to receive content corresponding to the marker information and the identification information included in the distribution request information, of the plurality of pieces of content, from the management server. Accordingly different pieces of content for respective users are displayed from the same marker.

### BACKGROUND

### Technical Field

The present invention relates to a content management device, a content request program, and the like.

### Related Art

In a case where a marker printed on a card or the like is read by a terminal, content associated with the marker can be displayed on a display unit of the terminal by use of an augmented reality (AR) technology.

JP 2014-89558 A discloses a technology for providing an AR system that reduces a load on a terminal to obtain more information. The technology described in JP 2014-89558 A is characterized in that a marker and content associated with the marker are recorded in a server to which a terminal is connected, and the server extracts and sends the content associated with the marker to the terminal when information of the marker is sent from the terminal to the server.

### SUMMARY

However, in the conventional technology as described in JP 2014-89558 A, the content to be displayed and the marker to be read by the terminal are associated with each other on a one-to-one basis. Therefore, in a case of displaying different kinds of content for respective users, it is necessary to prepare as many markers as the number of kinds of content to be displayed.

In view of the above circumstances, an object of the present invention is to display different pieces of content for respective users from the same marker.

A content request program according to the present invention causes a terminal to function as a capture unit configured to capture a marker image, an identification unit configured to acquire identification information for specifying content, an output unit configured to transmit distribution request information including marker information extracted from the marker image and the identification information to a management server that manages a plurality of pieces of content, and a reception unit configured to receive content corresponding to the marker information and the identification information included in the distribution request information, of the plurality of pieces of content, from the management server.

Note that, in the present specification and the like, the term “unit” does not only simply mean a physical configuration but also includes a case in which the function of the configuration is realized by software. Further, a function of one configuration may be realized by two or more physical configurations, or functions of two or more configurations may be realized by one physical configuration.

According to the present invention, different pieces of content can be displayed for respective users from the same marker.

### BRIEF DESCRIPTION OF DRAWINGS

FIG. 1 is a configuration diagram illustrating an example of a system configuration of a content management system according to an embodiment of the present invention;

FIG. 2 is a diagram illustrating an example of functional blocks of a terminal and a management server according to an embodiment of the present invention;

FIG. 3 is a diagram illustrating an example of a record of a content information DB according to an embodiment of the present invention;

FIG. 4 is a diagram illustrating an example of a record of a marker information DB according to an embodiment of the present invention;

FIG. 5 is a flowchart illustrating an example of a processing flow of a management server according to an embodiment of the present invention;

FIG. 6 is a diagram illustrating an example of functional blocks of a terminal in which a content creation program is installed according to an embodiment of the present invention;

FIG. 7 is a diagram illustrating an example of functional blocks of a terminal in which a content request program is installed according to an embodiment of the present invention;

FIG. 8 is a view illustrating an example of a marker capture screen according to an embodiment of the present invention;

FIG. 9 is a sequence diagram illustrating an example of a flow of individual content registration processing according to an embodiment of the present invention;

FIG. 10 is a sequence diagram illustrating an example of a flow of individual content distribution processing according to an embodiment of the present invention; and

FIG. 11 is a diagram illustrating an example of a hardware configuration of a management server and a terminal according to an embodiment of the present invention.

### DETAILED DESCRIPTION

### First Embodiment

Hereinafter, one of embodiments of the present invention will be described in detail. Note that the following embodiment is an example for describing the present invention and is not intended to limit the present invention to the embodiment only. Further, the present invention can be made into various modifications as long as the modifications do not depart from the gist of the invention. Further, a person skilled in the art can adopt embodiments in which the following elements are replaced with equivalent elements, and such embodiments are also included in the scope of the present invention. Furthermore, the positional relationships such as up, down, right, and left, and the like described as necessary are based on illustrated display unless otherwise stated. Furthermore, the various dimensional ratios in the drawings are not limited to the illustrated ratios.

<1. Overview of System Configuration>

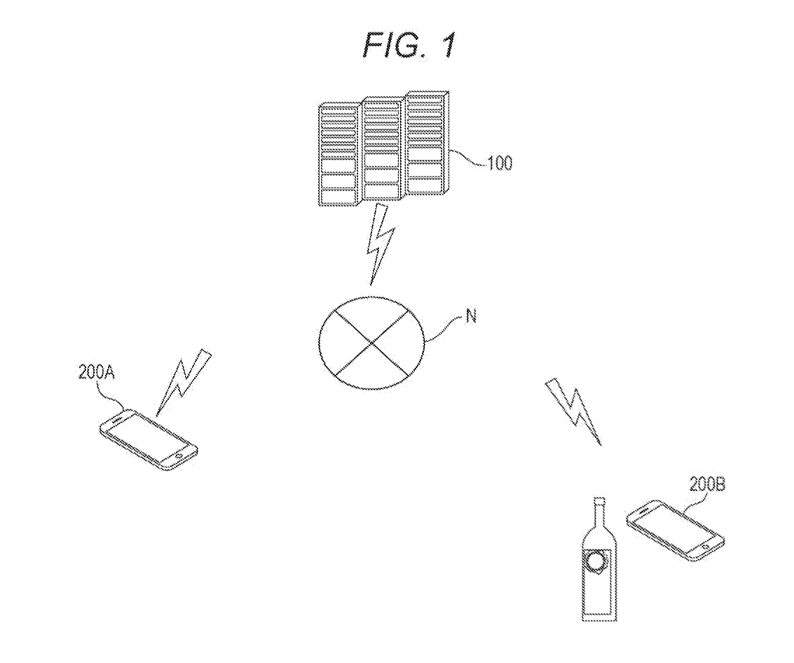

FIG. 1 illustrates an example of a system configuration of a content management system 1 according to the present embodiment. The content management system 1 according to the present embodiment distributes prepared content on the basis of an AR marker (hereinafter simply called “marker”) added to a product and information for identifying the content to be distributed (hereinafter called “identification information”). In the present embodiment, the content is an AR video. The AR video is a moving picture using the augmented reality, and is a moving picture superimposed on and reproduced with an image of a product when the product including the marker is captured. Note that the product is not only a product displayed by a certain user (hereinafter also called “registered user”) for sale to an unspecified number of consumers (hereinafter called “reproducing user”) but also a present to be given to a specific user.

As illustrated in FIG. 1, the content management system 1 includes a management server (an example of a content management device) 100 connected to a network N such as the Internet, and terminals 200A and 200B (hereinafter the terminals 200A and 200B are collectively called “terminal 200”).

The network N is configured by a wireless network or a wired network. Examples of the communication network include a mobile phone network, a personal handy-phone system (PHS) network, a wireless local area network (LAN), 3rd Generation (3G), Long-Term Evolution (LTE), 4th Generation (4G), WiMax (registered trademark), infrared communication, Bluetooth (registered trademark), a wired LAN, a telephone line, a power line network, and networks conforming to IEEE 1394 and the like.

The terminal 200 is a computer connected to the network N. Specifically, as the terminal 200, for example, a mobile phone, a smartphone, a personal computer (PC), a personal digital assistants (PDA), a tablet, a wearable terminal, or a game machine is assumed. However, the terminal 200 is not limited to the above examples. Note that the terminal 200 favorably includes a capture unit such as a camera. The following description will be given on the assumption that the registered user registers content using the terminal 200A, and the reproducing user reproduces the content using the terminal 200B. In this case, a content creation program for creating content is installed in the terminal 200A, and a content request program for requesting distribution of the content is installed in the terminal 200B.

The management server 100 is a computer connected to the network N, and examples include a PC and a server device. Note that the management server 100 is constructed on a cloud in the present embodiment.

<2. Functional Configuration of Management Server 100>

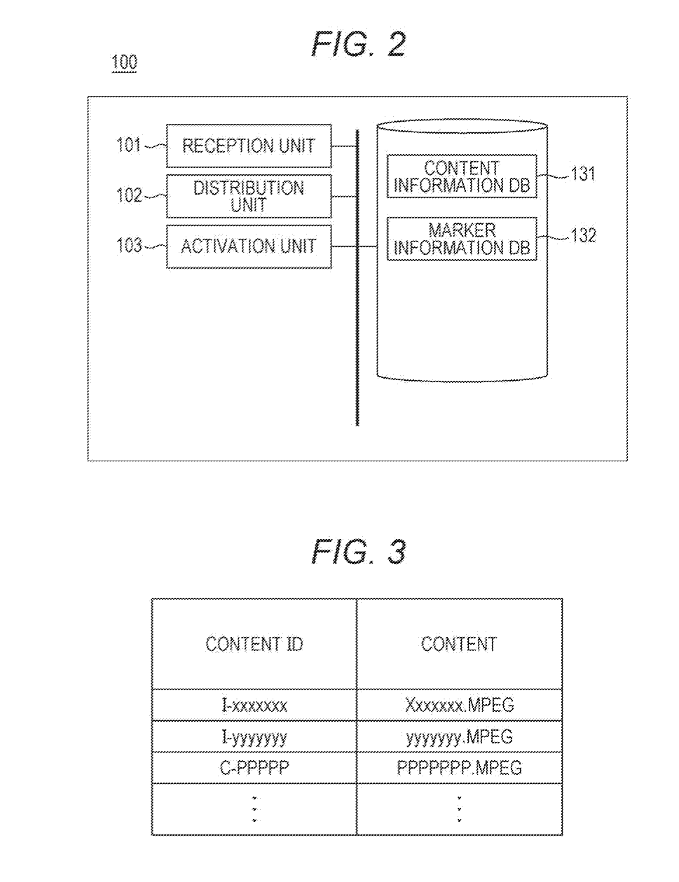

A functional configuration of the management server 100 according to the present embodiment will be described with reference to FIG. 2.

The management server 100 includes, for example, a marker information DB (an example of a marker information storage unit) 132, a content information DB (an example of a content information storage unit) 131, a reception unit 101, a distribution unit 102, and an activation unit 103.

(2-1. Database)

FIG. 3 is a diagram illustrating an example of content information DB 131. In the content information DB 131, content is associated with a content ID. Note that the content information DB 131 may be configured to be partitioned into areas respectively possessed by users. In the content information DB 131, two types of content, individual content and general-purpose content, are stored. The individual content is an AR video prepared for a specific partner by a registered user. Specifically, the individual content is a congratulatory message video for 60th birthday, a congratulatory message video for president's appointment of a business partner, a thank-you message video to wedding guests, and the like.

On the other hand, the general-purpose content is an AR video prepared for an unspecified number of consumers by a seller or the like of a product. Specifically, the general-purpose content is an advertisement video of a product, an explanation video of how to consume a product (how to drink, how to eat, how to use, or the like).

In the following description, the content ID associated with the individual content is also called individual content ID, and the content ID associated with the general-purpose content is also called general-purpose content ID.

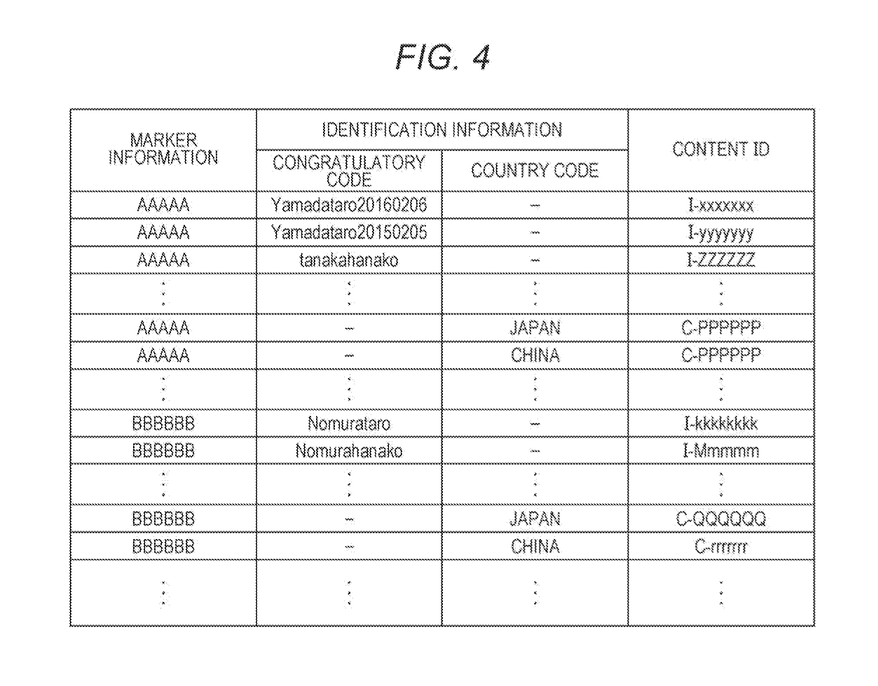

FIG. 4 is a diagram illustrating an example of the marker information DB 132 according to the present embodiment. In the marker information DB 132, the content ID and identification information are stored in association with marker information. The marker information is information for identifying a marker that is extracted when the terminal 200 described below reads a marker image.

The identification information is information for identifying content. In the marker information DB 132, the identification information associated with the marker information is either individual content identification information (an example of individual identification information) or general-purpose content identification information. More specifically, in the marker information DB 132, the individual content identification information is associated with the individual content ID, and the general-purpose content identification information is associated with the general-purpose content ID. Note that, in the marker information DB 132, a configuration in which the identification information is not associated with the general-purpose content ID may be adopted.

The individual content identification information is a congratulatory code in the present embodiment. The congratulatory code is an identifier that is added to and sent with a product when the registered user gives the product to the reproducing user. Note that the registered user can obtain the congratulatory code associated with the marker to be added to the product when purchasing the product, for example. Specifically, the congratulatory code includes, for example, an arbitrary character string of a name of the registered user, an anniversary, a combination thereof, or the like. Note that the individual content identification information is not limited to the congratulatory code, and may be, for example, terminal identification information (a phone number, a MAC address, or the like) of the terminal 200B, a mail address of the reproducing user, location information, or the like.

In the present embodiment, the general-purpose content identification information is a country code. The country code is a code for identifying a language for reproducing content. Note that the general-purpose content identification information is not limited to the country code, and may be, for example, information for identifying a shop that sells products or attribute information of the user.

Specifically, the information for identifying a shop is information included in shop location information or beacon information transmitted from a wireless LAN or the like installed in the shop. In the case where the general-purpose content identification information is the information for identifying a shop, each shop that sells products can distribute the general-purpose content according to the customers and the needs of each shop.

Meanwhile, the attribute information of the user is specifically age, sex, an address, an occupation, or the like of the reproducing user. In the case where the general-purpose content identification information is the attribute information of the user, a business entity that sells products can distribute the general-purpose content such as an advertisement according to the attribute of the user.

Referring back to FIG. 2, and the functional configuration of the management server 100 will be further described.

(2-2. Reception Unit 101)

The reception unit 101 performs registration reception processing and distribution reception processing.

Registration Reception Processing

The reception unit 101 receives content registration from the terminal 200A. For example, in a case where the reception unit 101 receives the congratulatory code together with the marker information and the content from the terminal 200A, the reception unit 101 issues the individual content ID to the received content. The reception unit 101 registers the issued individual content ID and the received content (individual content) to the content information DB 131. Further, the reception unit 101 selects a record corresponding to the received congratulatory code and marker information by reference to the marker information DB 132. This record has been added to the marker information DB 132 by the processing of the activation unit 103 to be described later. The reception unit 101 updates the marker information DB 132 by associating the issued individual content ID with the selected record.

Meanwhile, in a case where the reception unit 101 has not received the congratulatory code together with the marker information and the content from the terminal 200A, the reception unit 101 issues the general-purpose content ID to the received content. The reception unit 101 registers the issued general-purpose content ID and the received content (general-purpose content) to the content information DB 131. Furthermore, the reception unit 101 adds a record regarding the received marker information. The reception unit 101 updates the marker information DB 132 by associating the issued general-purpose content ID with the added record. In a case where the reception unit 101 receives the country code together with the marker information and the content, the reception unit 101 updates the marker information DB 132 by further associating the country code with the added record.

Distribution Reception Processing

The reception unit 101 receives content distribution request information from the terminal 200B. Although details will be described below, the distribution request information is information including at least the marker information to be transmitted when the terminal 200B requests the management server 100 to distribute content. The terminal 200B can transmit the distribution request information including the congratulatory code or the country code in addition to the marker information.

The reception unit 101 selects content to be distributed according to whether the distribution request information includes the marker information and the congratulatory code. Specifically, in a case where the congratulatory code is included in the received distribution request information, the reception unit 101 selects the individual content ID corresponding to the received congratulatory code by reference to the marker information DB 132.

On the other hand, in a case where the congratulatory code is not included in the received distribution request information, the reception unit 101 extracts the general-purpose content IDs corresponding to the marker information included in the received distribution request information by reference to the marker information DB 132. At this time, in a case where the country code is included in the received distribution request information, the reception unit 101 selects the general-purpose content ID corresponding to the country code from the extracted general-purpose content IDs. In a case where the received distribution request information does not include both the congratulatory code and the country code, the reception unit 101 selects the general-purpose content ID corresponding to a default country code (for example, Japan) specified in advance by a system administrator from the extracted general-purpose content IDs.

(2-3. Distribution Unit 102)

The distribution unit 102 extracts the content corresponding to the individual content ID or the general-purpose content ID selected by the reception unit 101 from the content information DB 131, and distributes the content to the terminal 200B.

(2-4. Activation Unit 103)

The activation unit 103 activates the congratulatory code. Specifically, the activation unit 103 adds a record in which the congratulatory code issued to the registered user and the corresponding marker information are associated with each other to the marker information DB 132.

(2-5. Processing Flow)

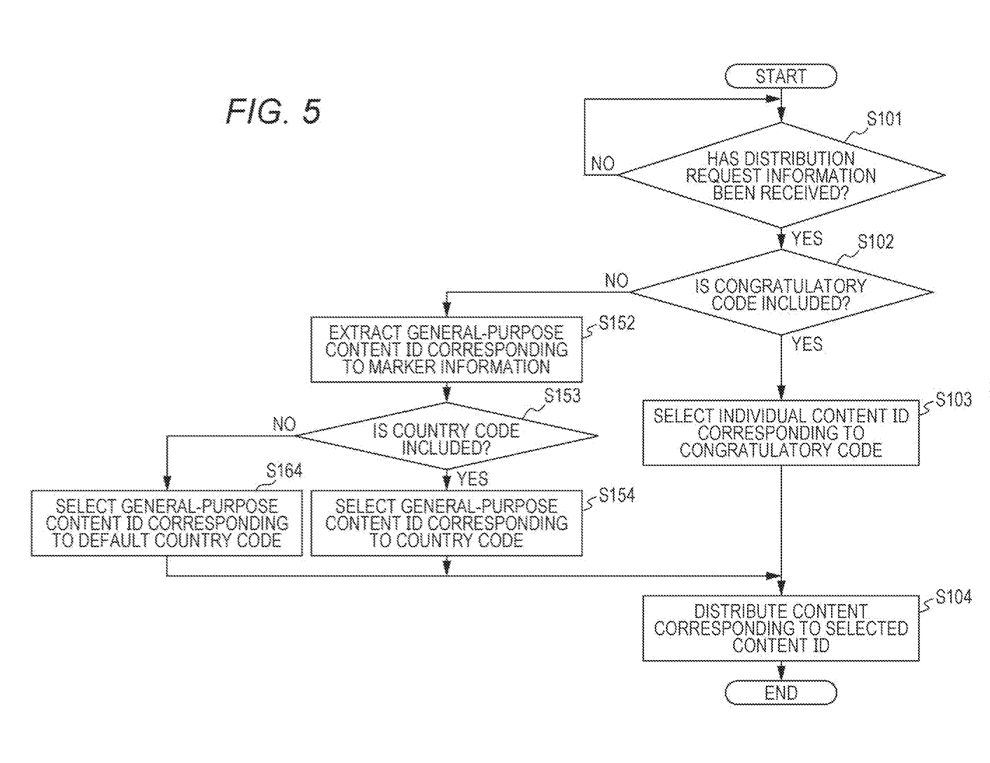

Content distribution processing in the management server 100 according to the present embodiment will be described with reference to FIG. 5. FIG. 5 is a flowchart illustrating a flow of the content distribution processing. Note that processing steps included in the flow of the processing described below can be arbitrarily changed in order or executed in parallel unless inconsistency arises in the processing content, and another step may be added to between the processing steps. Further, a step described as one step for convenience can be divided into a plurality of steps and executed. Meanwhile, a process separately described in a plurality of steps for convenience can be grasped as one step.

When the reception unit 101 in the management server 100 receives the distribution request information from the terminal 200B (S101: YES), the reception unit 101 determines whether the congratulatory code is included in the distribution request information (S102). In a case where the congratulatory code is included in the distribution request information (S102: YES), the reception unit 101 selects the individual content ID corresponding to the received congratulatory code by reference to the marker information DB 132 (S103).

On the other hand, in a case where the congratulatory code is not included in the distribution request information (S102: NO), the reception unit 101 extracts the general-purpose content ID corresponding to the marker information included in the distribution request information from the marker information DB 132 (S153). Further, the reception unit 101 determines whether the country code is included in the distribution request information (S153). In a case where the country code is included in the distribution request information (S153: YES), the reception unit 101 selects the general-purpose content ID corresponding to the country code from the extracted general-purpose content ID (S154). On the other hand, in a case where the country code is not included in the distribution request information (S153: NO), the reception unit 101 selects the general-purpose content ID corresponding to the default country code from the extracted general-purpose content ID (S164).

The distribution unit 102 extracts the general-purpose content corresponding to the selected content ID from the content information DB 131 and distributes the general-purpose content to the terminal 200B (S104).

As described above, the management server 100 according to the present embodiment selects and distributes the individual content to be distributed according to the congratulatory code, thereby to distribute different content for each terminal 200B from the same marker.

<3. Terminal 200A>

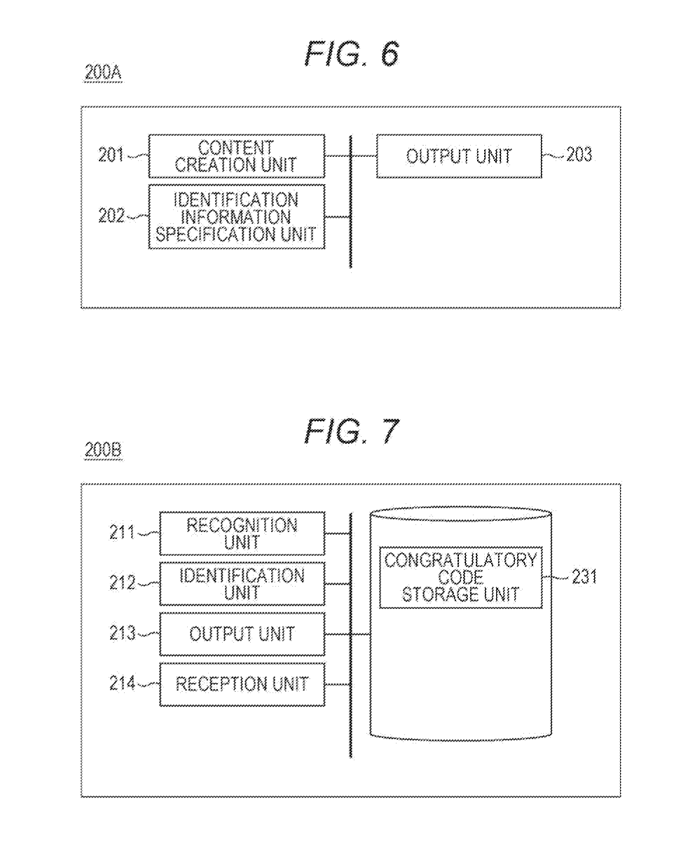

A functional configuration of the terminal 200A will be described with reference to FIG. 6. FIG. 6 is a functional block diagram of the terminal 200A in which the content creation program according to the present embodiment is installed. As illustrated in FIG. 6, the terminal 200A includes a content creation unit 201, an identification information specification unit 202, and an output unit 203.

(3-1. Content Creation Unit 201)

The content creation unit 201 processes a moving picture captured by the registered user into an AR video to create content. For example, the content creation unit 201 can delete background from the moving picture captured by the registered user.

(3-2. Identification Information Specification Unit 202)

The identification information specification unit 202 specifies the identification information to be associated with the content created by the content creation unit 201. The identification information specification unit 202 can specify the individual content identification information or the general-purpose content identification information.

Specification of Individual Content Identification Information

In the present embodiment, the identification information specification unit 202 specifies the input congratulatory code as the individual content identification information. For example, the identification information specification unit 202 can cause the terminal 200A to display a screen for inputting the congratulatory code. The registered user can input the congratulatory code acquired when purchasing a product to the terminal 200A, for example, using the screen displayed by the identification information specification unit 202. Note that the identification information specification unit 202 may be configured to specify the input location information (an address, latitude and longitude, or the like), the terminal identification information (a telephone number, a MAC address, or the like), a mail address, or the like, as the individual content identification information.

Specification of General-Purpose Content Identification Information

In the present embodiment, the identification information specification unit 202 specifies the selected country code as the general-purpose content identification information. For example, the identification information specification unit 202 can cause the terminal 200A to display a screen for selecting the country code. Note that the identification information specification unit 202 may be configured to specify the information for identifying a shop or the attribute information of the user as the general-purpose content identification information.

(3-3. Output Unit 203)

The output unit 203 outputs the content created by the content creation unit 201, the identification information specified by the identification information specification unit 202, and the marker information in association with one another to the management server 100.

<4. Terminal 200B>

Next, a functional configuration of the terminal 200B will be described with reference to FIG. 7. FIG. 7 is a functional block diagram of the terminal 200B in which the content request program according to the present embodiment is installed. As illustrated in FIG. 7, the terminal 200B includes a congratulatory code storage unit 231, a recognition unit 211, an identification unit 212, an output unit 213, and a reception unit 214.

(4-1. Congratulatory Code Storage Unit 231)

In the present embodiment, the congratulatory code storage unit 231 stores the congratulatory code and the marker information in association with each other. The terminal 200B includes the congratulatory code storage unit 231, so that the reproducing user can save the effort of inputting the congratulatory code again, which has been once input.

Note that the congratulatory code storage unit 231 may be configured to store the most recently input congratulatory code among congratulatory codes input by the reproducing user in the past. In this case, every time the identification unit 212 to be described below acquires a new congratulatory code, the congratulatory code storage unit 231 is overwritten with and stores newly acquired congratulatory content. Furthermore, the congratulatory code storage unit 231 may be configured to store the congratulatory code and an anniversary in association with each other. In this case, the terminal 200B can store the congratulatory code for each anniversary.

(4-2. Recognition Unit 211)

The recognition unit 211 controls the camera in the terminal 200B to capture the marker image attached to a product, and recognizes and extracts the marker information from the captured marker image.

(4-3. Identification Unit 212)

The identification unit 212 performs individual content identification processing of acquiring information for identifying requested individual content and general-purpose content identification processing of acquiring information for identifying requested general-purpose content.

Individual Content Identification Processing

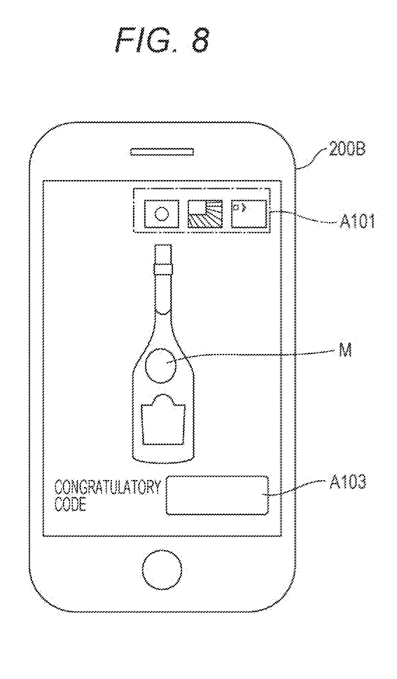

The identification unit 212 acquires the individual content identification information for identifying the individual content. In the present embodiment, the identification unit 212 acquires the congratulatory code as the individual content identification information. Specifically, the identification unit 212 causes the terminal 200B to display a marker capture screen including an input area for inputting a congratulatory code (details will be described below with reference to FIG. 8) when the recognition unit 211 causes the camera to capture the marker image.

For example, the identification unit 212 favorably causes the terminal 200B to display the marker capture screen including the input area only when the marker information acquired by the recognition unit 211 is not stored in the congratulatory code storage unit 231. The identification unit 212 obtains the congratulatory code from the character string input to the input area. The identification unit 212 stores the acquired congratulatory code in association with the marker information in the congratulatory code storage unit 231.

Note that the individual content identification information acquired by the identification unit 212 is not limited to the congratulatory code. For example, the identification unit 212 may be configured to acquire the location information, a terminal identification number (a telephone number, a MAC address, or the like) of the terminal 200B, a mail address, or the like, as the individual content identification information. In the case where the individual content identification information is the terminal identification number or the location information, for example, the identification unit 212 can automatically acquire the individual content identification information when the recognition unit 211 extracts the marker information.

General-Purpose Content Identification Processing

The identification unit 212 acquires the general-purpose content identification information for identifying the general-purpose content. In the present embodiment, the identification unit 212 acquires the country code as the general-purpose content identification information. Specifically, the identification unit 212 causes the terminal 200B to display a marker capture screen including a selection area for selecting a country code (details will be described below with reference to FIG. 8) when the recognition unit 211 causes the camera to capture the marker image. The identification unit 212 acquires the country code selected in the selection area.

Note that the identification unit 212 may be configured to automatically acquire the country code from the terminal 200B. In this case, the identification unit 212 can acquire the country code by reference to, for example, information of a language set in the terminal 200B and cookie information in the browser.

Furthermore, the general-purpose content identification information acquired by the identification unit 212 is not limited to the country code. For example, the identification unit 212 may be configured to acquire the information for identifying a shop as the general-purpose content identification information. In this case, the identification unit 212 can automatically acquire the general-purpose content identification information by reference to the location information of the terminal 200B, the beacon information received by the terminal 200B, and the like. Further, for example, the identification unit 212 may configured to acquire the attribute information of the user as the general-purpose content identification information. In this case, the identification unit 212 favorably operates in conjunction with an application for using a social networking service (SNS) or the like installed in the terminal 200B. As a result, the identification unit 212 can automatically acquire the attribute information of the user by reference to profile information registered in the SNS by the reproducing user who uses the terminal 200B.

(4-4. Output Unit 213)

The output unit 213 transmits the distribution request information to the management server 100. The output unit 213 transmits the distribution request information including the marker information extracted by the recognition unit 211 and the congratulatory code or the country code acquired by the identification unit 212 to the management server 100.

(4-5. Reception Unit 214)

The reception unit 214 receives and reproduces the content distributed from the management server 100.

<5. Screen Example>

FIG. 8 is a view illustrating an example of the marker capture screen according to the present embodiment. When the recognition unit 211 controls the camera to capture the marker image, the marker capture screen illustrated in FIG. 8 is displayed. In the example of FIG. 8, a marker image M of a captured product is displayed in the center of the screen. The recognition unit 211 recognizes and acquires the marker information from the captured marker image M.

The marker capture screen includes a country code selection area A101 and a congratulatory code input area A103. A national flag corresponding to the country code is displayed in the country code selection area A101 in the example of FIG. 8. The identification unit 212 can acquire the country code corresponding to the national flag selected by the reproducing user in the country code selection area A101.

Meanwhile, the congratulatory code input area A103 has a function to receive the character string input by the reproducing user. The identification unit 212 can acquire the input character string as the congratulatory code.

<6. Processing Sequence>

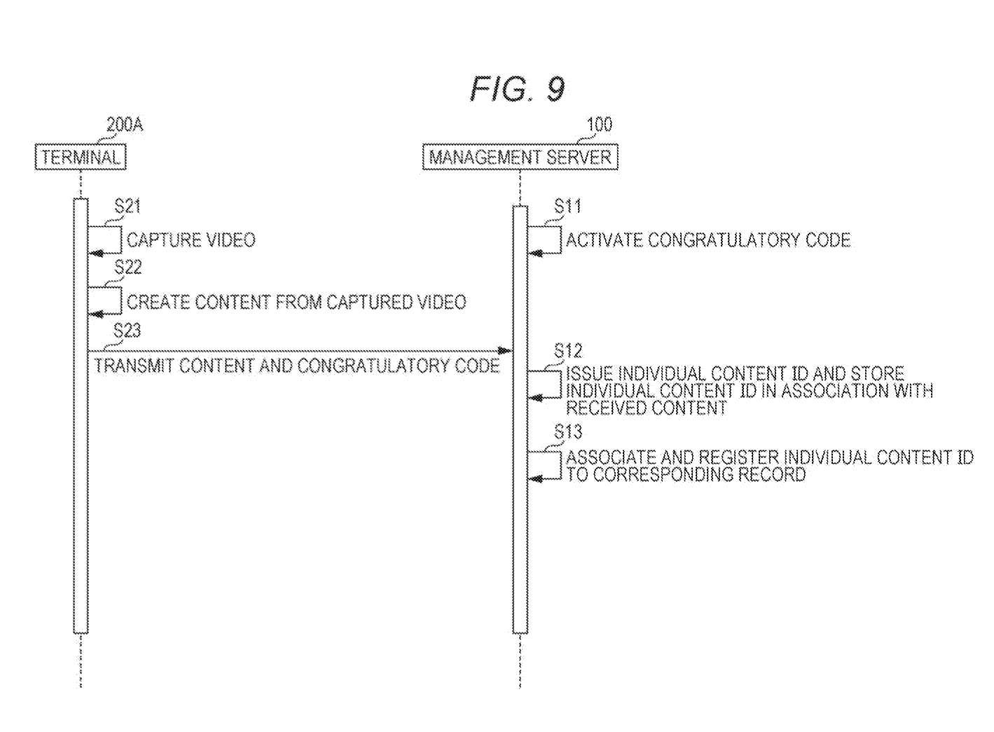

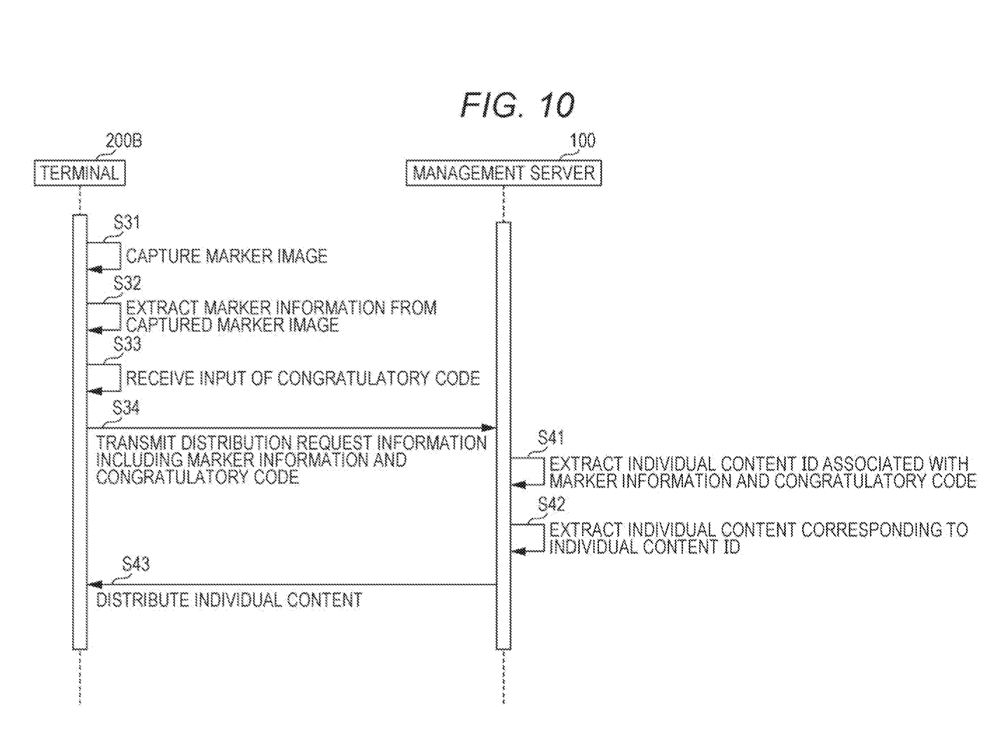

Sequences of individual content registration processing and individual content distribution processing of the content management system 1 according to the present embodiment will be described with reference to FIGS. 9 and 10.

FIG. 9 is a diagram illustrating a processing sequence of the individual content registration processing in the content management system 1 according to the present embodiment.

When the registered user purchases a product to be presented to the reproducing user, the registered user can obtain the congratulatory code at a shop where the registered user has purchased the product. When the congratulatory code is given to the registered user, the congratulatory code is activated by the activation unit 103 in the management server 100. For example, a server device installed in the shop favorably sends a notification to the activation unit 103 when giving the congratulatory code to the registered user. When received the notification, the activation unit 103 adds a record in which the congratulatory code and the corresponding marker information are associated with each other to the marker information DB 132 to activate the congratulatory code (S11).

The registered user, who has received the congratulatory code, captures a moving picture to be added to be product and presented, using the terminal 200A (S21). The captured moving picture is edited into an AR video by the content creation unit 201 (S22). The content creation unit 201 transmits the created individual content together with the congratulatory code to the management server 100 (S23).

The reception unit 101 of the management server 100, which has received the congratulatory code and the individual content, issues the individual content ID to the received individual content. The reception unit 101 registers the issued individual content ID and the individual content in association with each other to the content information DB 131 (S12). Further, the reception unit 101 registers the issued individual content ID to the record corresponding to the received congratulatory code and the marker information by reference to the marker information DB 132 (S13).

FIG. 10 is a diagram illustrating a processing sequence of the individual content distribution processing in the content management system 1 according to the present embodiment.

For example, the reproducing user who has received a present from the registered user by parcel delivery service or the like can obtain the congratulatory code from a message card or the like added to the present. The reproducing user captures the marker image added to the present, using the camera of the terminal 200B (S31). The recognition unit 211 in the terminal 200B extracts the marker information from the captured marker image (S32). At this time, the identification unit 212 causes the terminal 200B to display the marker capture screen illustrated in FIG. 8, for example, and acquires the input congratulatory code or country code (S33). In FIG. 10, the case in which the identification unit 212 acquires the congratulatory code will be described as an example.

The output unit 213 transmits the distribution request information including the marker information and the congratulatory code to the management server 100 (S34). The reception unit 101 in the management server 100 selects the individual content ID corresponding to the marker information and the congratulatory code included in the received distribution request information from the marker information DB 132 (S41).

Next, the distribution unit 102 extracts the individual content corresponding to the individual content ID from the content information DB 131 (S42). The distribution unit 102 distributes the extracted individual contents to the terminal 200B (S43).

According to the content management system 1 of the present embodiment, the content to be distributed can be extracted from the content information corresponding to the marker information according to the congratulatory code. With the configuration, different pieces of content can be provided to respective users from one marker image.

<Hardware Configuration>

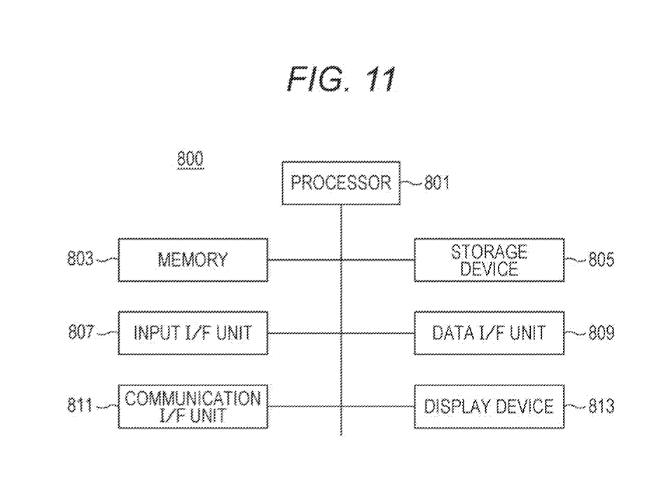

Hereinafter, an example of a hardware configuration in a case where the terminal 200 and the management server 100 described above in the first and second embodiments are realized by a computer 800 will be described with reference to FIG. 11. Note that the functions of the respective devices can also be realized by being divided into a plurality of devices.

As illustrated in FIG. 11, the computer 800 includes a processor 801, a memory 803, a storage device 805, an input I/F unit 807, a data I/F unit 809, a communication I/F unit 811, and a display device 813.

The processor 801 executes a program stored in the memory 803 to control various types of processing in the computer 800. For example, the reception unit 101, the distribution unit 102, and the activation unit 103 of the management server 100, the content creation unit 201, the identification information specification unit 202, and the output unit 203 of the terminal 200A, and the recognition unit 211, the identification unit 212, the output unit 213, the reception unit 214, and the like of the terminal 200B can be realized as a program mainly operating on the processor 801 after temporarily stored in the memory 803.

The memory 803 is a storage medium such as a random access memory (RAM) The memory 803 temporarily stores a program code of the program executed by the processor 801 and data required when the program is executed.

The storage device 805 is a nonvolatile storage medium such as a hard disk drive (HDD) or a flash memory. The storage device 805 stores an operating system and various programs for realizing the above-described configurations. In addition, the storage device 805 can store the content information DB 131, the marker information DB 132, and the congratulatory code storage unit 231. Such programs and data are loaded into the memory 803 as needed and referred to by the processor 801.

The input I/F unit 807 is a device for receiving an input from the user. Specific examples of the input I/F unit 807 include a keyboard, a mouse, a touch panel, various sensors, and a wearable device. The input I/F unit 807 may be connected to the computer 800 via an interface such as a universal serial bus (USB).

The data I/F unit 809 is a device for inputting data from the outside of the computer 800. A specific example of the data I/F unit 809 includes a drive device for reading data stored in various storage media. The data I/F unit 809 may be conceivably provided outside the computer 800. In this case, the data I/F unit 809 is connected to the computer 800 via an interface such as USB.

The communication I/F unit 811 is a device for performing data communication with a device outside the computer 800 via the Internet N by wired or wireless means. The communication I/F unit 811 may be conceivably provided outside the computer 800. In this case, the communication I/F unit 811 is connected to the computer 800 via an interface such as USB.

The display device 813 is a device for displaying various types of information. Specific examples of the display device 813 include a liquid crystal display, an organic electro-luminescence (EL) display, and a wearable device display. The display device 813 may be provided outside the computer 800. In this case, the display device 813 is connected to the computer 800 via a display cable or the like.

The above-described embodiments are for facilitating understanding of the present invention and are not intended to limit the present invention. The present invention can be modified/improved without departing from the spirit of the invention, and equivalents thereof are also included in the present invention. It should also be understood that the embodiments are illustrative, and that it is possible to partially substitute or combine the configurations illustrated in the different embodiments and these are also included in the scope of the present invention as long as they include the characteristics of the present invention.

What is claimed is:

1. A content request program for causing a terminal to function as:
a capture unit configured to capture a marker image;
an identification unit configured to acquire identification information for specifying content;
an output unit configured to transmit distribution request information including marker information extracted from the marker image and the identification information to a management server that manages a plurality of pieces of content; and
a reception unit configured to receive content corresponding to the marker information and the identification information included in the distribution request information, of the plurality of pieces of content, from the management server.

2. The content request program according to claim 1, wherein
the identification unit
acquires a predetermined code input by a user of the terminal as the identification information.

3. The content request program according to claim 1, wherein
the identification unit
acquires information regarding selection of a language for reproducing the content as the identification information.

4. A content management device comprising:
a content information storage unit configured to store individual content to be distributed to a specific user and an individual content ID in association with each other;
a marker information storage unit configured to store marker information for identifying a marker image, the individual content ID, and individual identification information for identifying the individual content to be distributed to a specific user in association with one another;
a reception unit configured to receive distribution request information from a terminal, and extract, in a case where marker information regarding a marker image captured by the terminal and the individual identification information are included in the distribution request information, the individual content ID corresponding to the marker information and the individual identification information from the marker information storage unit; and
a distribution unit configured to distribute the individual content corresponding to the extracted individual content ID to the terminal.

5. The content management device according to claim 4, wherein
the content information storage unit further
stores general-purpose content to be distributed to an unspecified number of users and an general-purpose content ID in association with each other,
the marker information storage unit further
stores the general-purpose content ID in association with the marker information,
the reception unit
extracts the general-purpose content ID corresponding to the marker information included in the distribution request information from the marker information storage unit in a case where the individual identification information is not included in the distribution request information, and
the distribution unit
distributes the general-purpose content corresponding to the extracted general-purpose content ID to the terminal.

6. The content management device according to claim 5, wherein
the marker information storage unit
further stores a country code representing a language for reproducing the general-purpose content in association with the marker information,
the reception unit
selects a general-purpose content ID corresponding to the country code from the extracted general-purpose content ID, and
the distribution unit
distributes the general-purpose content corresponding to the selected general-purpose content ID to the terminal.
